(19) United States
(12) Patent Application Publication
(10) Pub. No.: US 2022/0080617 A1
(43) Pub. Date: Mar. 17, 2022

(54) THREE-DIMENSIONAL PRINTING OF MULTILAYER CERAMIC MISSILE RADOMES BY USING INTERLAYER TRANSITION MATERIALS

(71) Applicant: ASELSAN ELEKTRONIK SANAYI VE TICARET ANONIM SIRKETI, Ankara (TR)

(72) Inventors: Hansu BIROL, Ankara (TR); Akin DALKILIC, Ankara (TR); Ozgur BIRER, Ankara (TR); Sebnem SAYGINER, Ankara (TR); Mehmet Erim INAL, Ankara (TR)

(73) Assignee: ASELSAN ELEKTRONIK SANAYI VE TICARET ANONIM SIRKETI, Ankara (TR)

(21) Appl. No.: 17/421,404

(22) PCT Filed: Jan. 9, 2019
(86) PCT No.: PCT/TR2019/050018

§ 371 Date: Jul. 8, 2021

(51) Int. Cl. B28B 1/00; C04B 35/64; B33Y 10/00; B33Y 70/10; B33Y 50/00; B33Y 40/20; B33Y 80/00; C04B 35/01; C03C 10/00

(52) U.S. Cl. CPC B28B 1/001; C04B 2235/96; B33Y 10/00; B33Y 70/10; B33Y 50/00; B33Y 40/20; B33Y 80/00; C04B 35/01; C03C 10/0045; C03C 10/0054; C04B 2235/365; C04B 2235/612; C04B 2235/6026; C04B 2235/3409; C04B 2235/3418; C04B 35/64

(57) ABSTRACT

Production of multilayered ceramic missile radomes with wide frequency band and high electromagnetic permeability through three-dimensional printing technology and the use of glass inter-layer materials to minimize defects caused by thermo-mechanical incompatibility of adjacent layers during sintering are provided. The three dimensional printing of the multilayered ceramic missile radomes provide an automated, operator-independent and repeatable manufacturing technique to produce wide band ceramic missile radomes.

### TECHNICAL FIELD

The invention relates to three-dimensional printing of ceramic missile radomes.

The invention is particularly related to a method using 3D printing technology to produce multilayer ceramic and glass-ceramic radomes providing high electromagnetic permeability in a wide frequency band and to the use of inter-layer materials to prevent the shrinkage mismatch-related defects between the layers of the radome during sintering process.

### PRIOR ART

Ceramic-based missile radomes (radar enclosure, radar dome) are traditionally produced by slip casting. This technique is suitable for the construction of ceramic radomes with constant wall thickness, operating at a specific RF (Radio Frequency). However, multilayer sandwich structures are needed for radomes that will operate in a wide frequency band with high electromagnetic permeability. The three-dimensional printing technique is suitable for a rapid, efficient and repeatable production of such structures within a flexible production model.

Three-dimensional printing is used for the development of specially-designed products which are difficult to produce with standard techniques. In its traditional application, it is a technique that comprises the melting of plastics at low temperatures and the extrusion of the melt through a nozzle. Due to the high equipment costs required to develop desired materials, and the limited interdisciplinary work, the three-dimensional printing of ceramics for production purposes has gained momentum only in the last decade.

The procedure followed in three-dimensional printing of ceramics is not different from that of traditional production technologies. According to this, the ceramic powder is first mixed to provide the homogeneity of the material, which is then shaped and sintered.

In industry, three-dimensional printing of ceramic materials advances in two directions. In the first group, the products, which are complex and small in size (<10 cm×10 cm×10 cm), are printed at high resolution (μm level). In the other approach, larger products (>30 cm×30 cm×30 cm) are printed rapidly at a lower resolution (mm level). The common point of both routes is the fundamental need to investigate and to develop the optimized printing technique and production process for each material of interest thoroughly.

The printing of small and intricate ceramics can be examined in two groups as direct and indirect printing. In direct printing, the layer to be printed is sintered with high energy source (laser, electric field, electron beam) without additive materials and the process is repeated for each new layer. SLS (Selective Laser Sintering), SLM (Selective Laser Melting), SPS (Spark Plasma Sintering) are the techniques used in this field. In indirect printing, the ceramic powder is mixed with an organic additive which gives the green density of each layer. This material acts as a binder, which is activated by heat or UV application to pack ceramic powders closer. The object can be printed with lithographic techniques, such as LOM (Laminated Object Manufacturing), FDM (Fused Deposition Modeling—extrusion without heating the nozzle), DLP (Digital Light Processing) and Lithography-based Ceramic Processing (LCP), and then sintered. Among these techniques, lithography provides more precise and reproducible results. In this technique, the ceramic powder is mixed with a by-light-curable organic binder, which is then printed and exposed to light. As a result of this step, the photo-initiator in the structure is activated, and the photopolymerization process is initiated. After all the layers are printed following this procedure, the printed object is sintered. Several industries are already using the 3D printed ceramic parts in their applications, which influences 3D ceramic printer manufacturers to develop printers for larger ceramics faster and with higher resolution.

Extrusion is the most appropriate technique in mass printing of larger ceramics. The technique is based on the extrusion of ceramic slurry with optimized viscosity and plasticity, through the nozzle of the printer and its layer by layer printing with a semi-automatic machine.

One of the applications in the research concerning three-dimensional ceramic printing is the patent application no. TW1614122 (B), entitled as “Manufacturing method of three-dimensional ceramic and composition thereof.” The application involves printing a single layer ceramic product using a three-dimensional printer and glazing and firing processes of the obtained object.

Another application is a patent application no. CN105254309 (B), entitled as “Ceramic 3D printing method”. The application involves the production of single-layer ceramic products by mixing ceramic powders with a binder and using SLS (Selective Laser Sintering) method in three-dimensional printers.

There is no information available on the three-dimensional printing of multilayered ceramic radomes and on the use of inter-layer materials to prevent product defects due to the thermo-mechanical incompatibility between the bulk layers of the radome in the open literature.

Ceramic missile radomes are manufactured with slip casting technique. This technique is one of the oldest and most common methods used to produce large and complex shaped ceramics. In this technique, ceramic particles are dispersed in aqueous or organic vehicle, stabilized, and then cast into previously prepared plaster molds in the form of the radome. While the plaster mold permeates the water in the mixture through its porous structure, the ceramic particles accumulate on the surface of the mold. The thickness of the deposited material is determined as a function of time and experimentally. Mixture properties (solid/liquid ratio, stability of the mixture, grain size and particle distribution), mold material (plaster/water ratio, plaster pore size and distribution), ambient temperature and humidity, the knowledge, experience and skills of the operator are major factors affecting the quality of the product directly. Upon termination of the deposition, the remaining slurry is drained out. The piece is removed from the mold after drying and left at room temperature for several days. In the next process, the ceramic is sintered in the furnace and it reaches to its final density and microstructure. As there is no thickness control, the parts from the kiln are machined to fulfill the desired tolerances at the micron level. Considering all these operations, in slip casting production:
Prototype and product development processes are long and dependent on very meticulous and simultaneous control of many parameters. For this reason, it is not a production technique that is flexible and reproducible.
Coarse thickness is obtained at mm levels after sintering and the desired final thicknesses is obtained by machining the piece to comply with tolerances. This process does not only consume time, but it also: (1) Shortens the tool life in CNC (Computer Numerical Control) machines; (2) Increases the production costs; (3) Leads to the fracture of products with thin walls.
The deposited thickness is limited by the pores in the mold, which are closed by time.
The productivity depends on the technical knowledge, experience and skill set of the operator.
The reproducible production of multilayer materials with this technique consumes long time.

The three-dimensional printing of multilayer ceramic radomes and the technical problems encountered in this process are not mentioned in the open literature. Difficulties arising from specific technical processes are to be solved by the developments in technology. Especially during the sintering process, fractures or delamination due to the thermal expansion differences between the layers are among the subjects that are waiting to be explained.

As a result, due to the above-mentioned drawbacks and the inadequacy of the existing solutions, an improvement in the technical field has been required.

### BRIEF DESCRIPTION OF THE INVENTION

The present invention is related to the three-dimensional printing of multilayer ceramic missile radomes using inter-layer transition materials that meet the above-mentioned requirements.

The primary purpose of the invention is to provide a method using 3D printing technology to produce multilayer ceramic and glass-ceramic radomes, which will provide high electromagnetic permeability in a wide frequency band.

Another purpose of the invention is to minimize the defects caused by the thermo-mechanical mismatch between the bulk layers of the radomes in sintering by using glass and the materials alike in the three-dimensional printing of multilayer ceramic and glass-ceramic radomes.

Another purpose of the invention is the direct transfer of three-dimensional design of the ceramic radome as a CAD (Computer-aided Design) file to the three-dimensional printing machine, which facilitates the implementation of the design-related modifications in the radome quickly on the computer.

Another purpose of the invention is to provide an automated, operator-independent and repeatable production method to produce multilayer ceramic missile radomes.

Another purpose of the invention is to provide a method of production which eliminates costly and time-consuming design and production of the mold/negative-mold components by using three-dimensional printing technology.

Another purpose of the invention is to provide a production method which, according to the nature of the binder used, allows the printed substrate to be machined in the green state, in other words before sintering. This process is much faster than machining the sintered structure. In this way, the product is obtained with tolerances closer to the desired values after sintering. The additive and subtractive processes can be used together in the development of printed products.

Another purpose of the invention is to provide an ideal production method to produce multilayered ceramic missile radomes with any complex shapes such as pits, protrusions, recesses and the geometries alike.

Another purpose of the invention is to produce multilayered ceramic missile radomes by using the multi-nozzle extrusion method to print a new material on top of a previously-printed different material.

Another purpose of the invention is to provide mass customization by printing objects with different designs on the same device platform simultaneously due to the use of 3D printing technology. Accordingly, this allows for fast testing of different product designs (as a dummy or in final version).

Another purpose of the invention is to shorten the time to market in the production of multilayer ceramic missile radomes.

Another purpose of the invention is to reduce waste and to minimize the loss of energy and materials in the production of multilayered ceramic missile radomes by conventionally-manufactured products.

In order to fulfill the above-mentioned purposes, the invention is a method using 3D printing technology to produce multilayer broadband ceramic and glass-ceramic missile radomes providing high electromagnetic permeability comprising the steps of;
i. preparing the feed material to print by mixing the predetermined compositions of at least a ceramic/glass-ceramic powder selected for each layer with adequate organic binders that enhances particle packing and by filling each mixture (layer) into the single containers (cartridge, tube, etc.) of the multi-nozzle 3D printing machine,
ii. repeating step (i) for inter-layer transition material, which is stated as glass in here, but can be extended to other glassy materials.
iii. preparing a computer-aided design file of the three-dimensional model of the desired radome and transferring the file to the 3D printing machine,
iv. initiating multi-nozzle extrusion printing process in the 3D printing machine in accordance with the printing order of the ceramic and transition layers,
v. drying of the green body printed in layers,
vi. machining of the green body to bring the object closer to the near-net shape after firing,
vii. sintering of the printed green body.

In order to fulfill the purposes of the invention, the method further comprises the step of using glass and alike materials to prevent cracks and delamination caused by CTE (Coefficient of Thermal Expansion) mismatch between the radome layers.

In order to fulfill the purposes of the invention, the method further comprises the step of the green body machining after the step (v.).

In order to achieve the purposes of the invention, the sintering process is performed at temperatures below 500° C. and at heating rates of less than 1° C./min for debinding and degassing of the organic binder.

In a preferred embodiment of the invention, said layers are selected from the ceramic/glass-ceramic materials to form a multilayered radome with sandwich structure, of which the inner and outer layers are thin, and the dielectric constant is high, and of which the middle layer is thick, and the dielectric constant is relatively low. This structure comprised of described layers can be prepared as repeating units.

In another embodiment of the invention, said layers are selected from the ceramic/glass-ceramic materials to form a multilayered radome with sandwich structure, of which the inner and outer layers are thick, and the dielectric constant is low, and of which the middle layer is thin, and the dielectric constant is relatively high. This structure comprised of described layers can be prepared as repeating units.

In another embodiment of the invention, said layers are selected from the ceramic/glass-ceramic materials to form a multilayered radome with functionally-graded material structure of which density/dielectric constant of each layer vary.

In another preferred embodiment of the invention, said layers are selected from ceramic/glass-ceramic materials to form a multilayered radome of which each layer is selected from different segments vertically according to the position of the RF seeker head.

In a preferred embodiment of the invention, said ceramic/glass-ceramic materials are selected from the group consisting of SiO₂ (Silicon dioxide), Si₃N₄ (Silicon nitride), RBSN (Reaction Bonded Silicon Nitride), Al₂O₃ (Aluminum oxide), SiAlON (Silicon alumina nitride), LAS (Lithium Aluminum Silicate), MAS (Magnesium Aluminum Silicate). In a preferred embodiment of the invention, LAS is glass-ceramic material composed of Lithium-Aluminum-Silicate oxides in varying proportions around the principal composition 1Li₂O₃.1Al₂O₃.2SiO₂ and MAS is glass-ceramic material composed of Magnesium-Aluminum-Silicate oxides in varying proportions around the principal composition 2MgO.2Al₂O₃.5SiO₂. Other oxide and non-oxide materials with appropriate electromagnetic characteristics can also be prepared according to the technique and guidelines described in this invention.

In order to fulfill the purposes of the invention, said glass inter-layer elements are selected from the group consisting of silicate glass oxides, borate glass oxides, compositions of said glass oxides with modifying oxides from groups 1A and 2A of the periodic table, and intermediate oxides. The silicate glass mentioned here is SiO₂ (Silicon dioxide); the said borate glass is B₂O₃ (Boron trioxide); the said modifying oxides are Na₂O (Sodium oxide), K₂O (Potassium oxide), Li₂O (Lithium oxide), CaO (Calcium oxide), MgO (Magnesium oxide), BaO (Barium oxide) or PbO (Lead oxide); and the said intermediate oxides are Al₂O3 (Aluminium oxide), Bi₂O₃ (bismuth III oxide) or TeO₂ (Tellurium dioxide) [1,2].

In a preferred embodiment of the invention, said glass inter-layer elements are PbO—B₂O₃—SiO₂ (PBS), ZnO—B₂O₃ (ZB), BaO—ZnO—B₂O₃ (BZB), La₂O₃—B₂O₃—ZnO (LBZ), BaO-Al₂O₃—SiO₂ (BAS), Li₂O—B₂O₃—SiO₂, (LBS), Li₂O—B₂O₃—SiO₂—CaO—Al₂O₃ (LBSCA), or BaO—B₂O₃—SiO₂ (BBS).

The invention also involves multilayered ceramic/glass-ceramic radomes produced by the said method. The radome structures mentioned here are used in missile radomes operating at supersonic and hypersonic speeds and in the broad/narrow frequency band, in embodiments required for high-speed aircraft or their components, or in electromagnetic windows and caps.

The structural and characteristic features and all advantages of the invention outlined in the drawings below and in the detailed description made by referring these figures will be understood clearly, therefore the evaluation should be made by taking these figures and detailed explanation into consideration.

### BRIEF DESCRIPTION OF THE FIGURES

FIG. 1 is a general view of the typical missile and radome structure.

FIG. 2A is the cross-section view of the A-sandwich radome structure that can be produced by three-dimensional printing.

FIG. 2B is the cross-section view of the B-sandwich radome structure that can be produced by three-dimensional printing.

FIG. 2C is a cross-sectional view of the FGM (Functionally Graded Material) radome structure that can be produced by three-dimensional printing. (The properties of material A (density, dielectric constant) gradually change in the thickness direction (A′, A″) accordingly.)

FIG. 2D Is a cross-sectional view of a multi-segment (A, B, C) radome structure that can be produced by three-dimensional printing.

### REFERENCE NUMBERS

1 Missile
10 Radome
20 Radar
30 Flange
A, ceramic/glass-ceramic radome material with a dielectric constant higher than B
A′, ceramic/glass-ceramic radome material with different dielectric constant/density from A
A″, ceramic/glass-ceramic radome material with different dielectric constant/density from A or A′
B, ceramic/glass-ceramic radome material with a dielectric constant lower than A
C, ceramic/glass-ceramic radome material with a dielectric constant different from A or B

### DETAILED DESCRIPTION OF THE INVENTION

In this detailed description, three-dimensional printing of the multilayer ceramic missile radomes of the invention are explained only for a better understanding of the subject matter and without any restrictive effect.

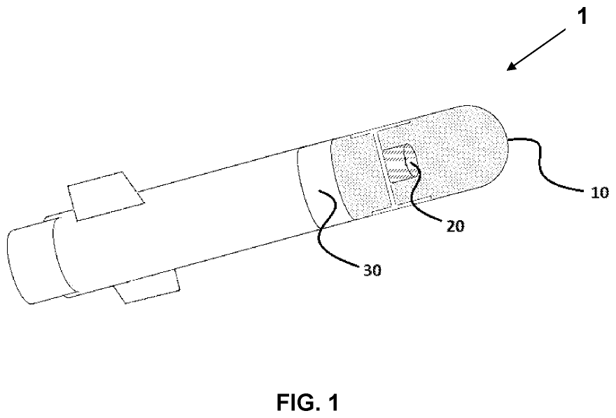

FIG. 1 shows a typical missile (1) image showing the radar (20) protected by a radome (10) and the flange (30) structure it is connected to. The ceramic radome (10) is one of the most critical components of the missiles flying at high speeds (1). This is mainly due to the temperatures resulting from the aerodynamic frictions that can rise up to 1000° C. in the nose of the radome (10) in a very short time, and to the acceleration loads resulting from the sudden maneuvers over the radome (10). To protect the radar and the electronic circuitry and to guarantee the desired RF performance of the missile, the radome (10) is produced by using the optimum design, materials, and manufacturing technique.

Slip casting is a standard production technique used for making large, asymmetric and complex designed ceramics which cannot be prepared by molding, extrusion, pressing, or hot pressing. For this reason, it is often used in the production of ceramic missile radomes. In this technique, the ceramic powder is first prepared in an aqueous solution with optimized rheology, which is then poured into plaster molds. When the water of the slurry is filtered from the porous gypsum, the ceramic accumulates on the walls of the gypsum and reaches a certain thickness. After a period of time, which is determined by empirical methods, the cast ceramic is removed from the mold, dried and then sintered. Following this process, machining and polishing operations are performed on and under the radome surface in order to attain the desired geometric tolerances.

Missile radomes are also manufactured using LAS (Lithium Aluminum Silicate) and MAS (Magnesium Aluminum Silicate) based glass ceramics. These materials are prepared by melting, casting and then firing of the glass. The firing process consists of nucleation and crystallization steps through which, the amorphous glass is gradually converted to the crystalline structure by devitrification.

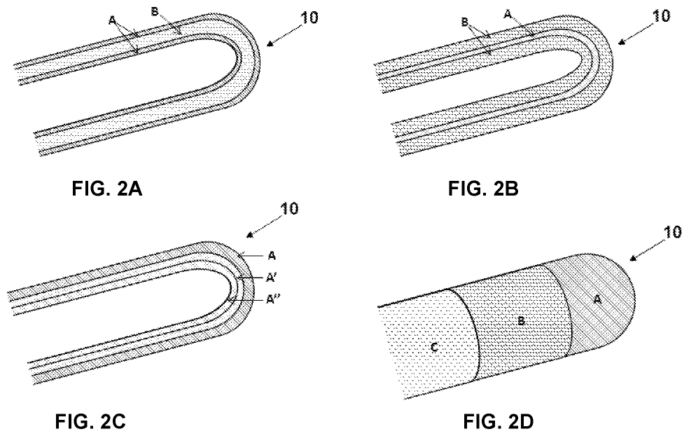

In both methods of radome production, the control of the technical parameters is difficult, efficiency is limited, and tool/process losses in post-casting machining operations are high. For these reasons, three-dimensional printing is emerging as a suitable technique for radome production at high efficiency and yield. Through this technique, it is possible to develop multilayer sandwich structures that provide high electromagnetic permeability in a wide frequency band. Accordingly,
1. embodiments comprising the inner and outer layers of which materials are thin and having high dielectric constant (A); and comprising the middle layer of which material is thick and having relatively low dielectric constant (B) (FIG. 2A),
2. embodiments comprising the inner and outer layers of which materials are thick and having low dielectric constant (B); and comprising the middle layer of which material is thin and having relatively high dielectric constant (A) (FIG. 2B),
3. embodiments being formed functionally-graded materials of which the density/dielectric constant properties of each layer vary (A, A′, A″) (FIG. 2C),
4. embodiments being formed vertically different segments (A, B, C) materials according to the position of the RF seeker (FIG. 2D),
   can be developed with three-dimensional printing.

The points that the three-dimensional printing of ceramic missile radomes are basically separated from the slip casting technique can be summarized as follows:
The design is transferred directly from CAD (Computer-aided design) file to the printer without the need for any tools. For this reason, changes and improvements to the product are quickly performed on the computer. This provides additional advantages in the assembly of the radome with other components (flange, etc.).
It is an automated process and is independent of the operator. It is therefore highly reproducible.
The costly and time-consuming design and production of the mold/negative-mold components are not required.
According to the nature of the binder used, it allows the printed substrate to be machined in the green state, in other words before sintering, which is much faster to accomplish compared to machining of the sintered structure. In this way, the product is obtained with tolerances close to the desired values after firing. In this way, it provides a production method in which the additive and subtractive processes can be used together.
It is an ideal production method to produce complex shapes such as pits, protrusions, recesses.
A material can be printed on top of another material using a multi-nozzle tip.
It provides mass customization by printing the multiple designs of the radome on the same device platform simultaneously. Accordingly, this allows for fast testing of different product designs (as a dummy or in final version).
Time to market has been shortened.
There is no loss of material properties in comparison with conventionally manufactured products.
The energy and material loss are minimized, and waste is reduced.

When considered as a production method, the highest resolution is achieved by lithography technique in the three-dimensional printing of ceramics. In this method, the radome material, that is a ceramic or glass ceramic powder, is mixed with a photocurable organic binder at a certain proportion. The determination and optimization of the rheology of the mixture is an important process. The binder in the mixture has two basic functions: (1) Keeping ceramic powder and organic binders together; (2) converting the mixture into solid “green body” consistency by the photo-initiator in its composition. The most important parameters in the forming process are the thickness of the printed layer, the intensity of the light source used and the duration of exposure to light.

The production process is initiated as the energy from the light source activates the photo initiator in the binder. In this way, new radicals are formed directly or through the reaction with other molecules. This process is called photo polymerization. After each layer is printed, photo-curing is applied, and the process is repeated until the print object is complete. The object printed in layers becomes ready for sintering after being dried.

The sintering process is one of the most fundamental steps in three-dimensional printing. The debinding and degassing of the organic binder in the structure is performed at low temperatures (<500° C.) and at sensitive heating rates (<1° C./min). The purpose of doing so is to prevent cracks that may occur during debinding process. For this reason, analytical methods such as dilatometry, TGA (Thermo Gravimetric Analysis) and DSC (Differential Scanning Calorimetry) must be used to determine the critical processing temperatures and heating profile. The other critical temperatures in firing are the sintering temperature, duration, and atmosphere in which ceramic material gains its properties. At this temperature the material reaches high density and the resulting microstructure determines the properties that the material will have in application. Although the sintered material is in the “near net shape” dimensions, it is forwarded to machining to comply with the final tolerances.

In the open literature, three-dimensionally printed materials using the Lithography-based Ceramic Manufacturing (LCM) method, are Al₂O₃ (Aluminum oxide), ZrO₂ (Zirconium dioxide), and Si₃N₄ (Silicon nitride). It is stated that these materials made of high purity raw materials have over 99% of their theoretical densities and their mechanical and electrical properties are comparable to or even superior to those of the same materials produced by other methods. However, these are relatively small structures.

Considering the size of ceramic missile radomes, the lithography technique developed for smaller objects, is expected to be a more comprehensive solution only in the medium/long term. The production of such structures with extrusion is a more appropriate approach for prototyping large ceramic radomes, despite the lower resolution of the print. In this technique, ceramic slurry with optimized rheology is printed three dimensionally with a semi-automatic system from the nozzle. The object is then dried and sintered. Multiple extrusion nozzle can be used for printing multiple materials on top of each other. The printing device is fed with special cartridges or tubes for each desired material. Each cartridge/tube can be connected to a single nozzle and activated by applying high pressure by the machine according to the printing order of the layers.

The greatest obstacle to the printing of multilayer ceramic structures is the formation of delamination and cracks between the layers due to the mismatch of the thermal expansion coefficients. This problem is often seen in multilayer ceramic structures such as capacitors, piezo-actuators, ceramic modules, fuel cells and thick-film sensors that are simultaneously fired at elevated temperatures.

Molten SiO₂ (Silicon dioxide), Si₃N₄ (Silicon nitride), RBSN (Reaction Bonded Silicon Nitride), Al₂O₃ (Aluminum oxide), SiAlON (Silicon alumina nitride), LAS (Lithium Aluminum Silicate) (1Li₂O₃.1Al₂O₃.2SiO₂), MAS (Magnesium Aluminum Silicate) (2MgO.2Al₂O₃.5SiO₂) and similar materials are the examples of ceramic/glass ceramic radome materials discussed within the present invention. To ensure broadband high electromagnetic permeability, these materials must be printed as multilayers. (FIGS. 2A, 2B, 2C, 2D). Thermo-mechanical compatibility between layers during sintering is possible by using transition materials (buffers) those do not impair electromagnetic, thermal, mechanical, thermo-mechanical performance requirements expected from the radome. The formulation of these materials, material purity, particle size and distribution, form factors (powder, wax, plate), designs (single/multi-line printing, different patterns), print thicknesses, temperature, humidity, corrosion resistance should be carefully optimized in accordance with the matrix material.

The present invention involves the use of glass as a transition material compensating the mismatch of CTE (Coefficient of Thermal Expansion) between ceramic layers. Glass is an effective transition material as an inter-layer material since it can be formulated and prepared in different properties and form factors (powder, paste, melt) to adopt the neighboring layers.

The glasses used in RF applications are produced by mixing the network former oxides with network modifier oxides. The network former oxides are SiO₂ (Silicon dioxide-silicate glass) with high melting point and viscosity, and B₂O₃ (Boron trioxide-borate glass) with low viscosity. In addition, network modifier oxides from 1A and 2A groups of the periodic table [Na₂O (Sodium oxide), K₂O (Potassium oxide), Li₂O (Lithium oxide), CaO (Calcium oxide), MgO (Magnesium oxide), BaO (Barium oxide)] and PbO (Lead oxide) participate into SiO₂, into B₂O₃ or into the composition of both oxides together. The modifier oxides facilitate the structure to be opened up by creating oxygen sites that are not connected to the glass, thereby increasing CTE and ionic conductivity at the same time. Apart from these, there is also an oxide group in the glass composition called intermediate oxides (Al₂O₃ (Aluminium oxide), Bi₂O₃ (bismuth(III) oxide), TeO₂ (Tellurium dioxide)) which contribute as a network former or as a network modifier according to the composition of the glass.

By using the glasses in the aforementioned groups, unlimited number of new glass compositions with attractive features can be obtained. The important thing is the compatibility of the selected glass with the thermo-mechanical and chemical properties of the bulk radome layers to be printed. It is also preferred that the glass has a small CTE value for its high thermal shock resistance. Table 1 shows the variation of the values of Tₛ (Softening Temperature), CTE, dielectric constant (ε), dielectric loss (tg δ) for PbO—B₂O₃—SiO₂ system, as a function of Pb—B—Si oxides [1].

Apart from this, by combining the components in the ZnO—B₂O₃, BaO—ZnO—B₂O₃, La₂O₃—B₂O₃—ZnO, SiO₂—BaO—Al₂O₃, Li₂O—B₂O₃—SiO₂, Li₂O—B₂O₃—SiO₂—CaO—Al₂O₃, BaO—B₂O₃—SiO₂ glass groups in different compositions, new glasses compatible with the bulk radome layers can be produced [1]. The glass should be developed carefully considering its composition, thickness, shape, and its impact on environment.

TABLE 1
Material Properties Based on The Glass Composition

| Material | Ts | CTE | | tg δ |
|---|---|---|---|---|
| (Vol. %) | (° C.) | (ppm/K) | ε | (@ 1 MHz) |
| PbO—B₂O₃—SiO₂ (70:20:10) | 348 | −155 | 19.57 | 0.020 |
| PbO—B₂O₃—SiO₂ (60:20:20) | 312 | −124 | 15.32 | 0.018 |
| PbO—B₂O₃—SiO₂ (50:40:10) | 408 | −98 | 13.78 | 0.012 |
| PbO—B₂O₃—SiO₂ (40:40:20) | 449 | −69 | 12.74 | 0.009 |
| PbO—B₂O₃—SiO₂ (40:20:40) | 442 | −31 | 12.11 | 0.010 |
| PbO—B₂O₃—SiO₂ (30:60:10) | 492 | −15 | 9.06 | 0.011 |

Glass ceramic radome materials can be printed in multiple layers using a suitable glass or by changing the proportions of the components in their composition (without requiring any extra glass). For example, Li₂O—Al₂O₃—SiO₂ based LAS glass ceramic can be prepared by using MgO, ZnO, K₂O, Na₂O, P₂O₅, TiO₂, ZrO₂ and As₂O_{2,5} additions at different ratios, or can be developed with different physical, mechanical, thermal, electrical properties only by varying the process parameters in nucleation and crystallization processes. It is possible to print the layers from multiple extruder nozzles by changing the glass composition to produce either a functionally-graded structure (FIG. 2C) or a segmented one (FIG. 2D).

In the light of previous explanations, the invention is a method using 3D printing technology to produce multilayer ceramic/glass-ceramic radomes providing high electromagnetic permeability in a wide frequency band, comprising the steps of;
preparing the feed material to print by mixing the predetermined compositions of at least a ceramic/glass-ceramic powder selected for each layer with adequate organic binders that enhances particle packing and by filling each mixture (layer) into the single containers (cartridge, tube, etc.) of the multi-nozzle 3D printing machine,
repeating step (i) for inter-layer transition material, which is stated as glass in here, but can be extended to other glassy materials.
preparing a computer-aided design file of the three-dimensional model of the desired radome and transferring the file to the 3D printing machine,
initiating multi-nozzle extrusion printing process in the 3D printing machine in accordance with the printing order of the ceramic and transition layers,
drying of the green body printed in layers,
machining of the green body to bring the object closer to the near-net shape after firing,
sintering of the printed green body.
   and involves the use of glass inter-layer elements to prevent cracks caused by CTE (Coefficient of Thermal Expansion) mismatch between said layers.

The printing of multilayer ceramic/glass-ceramic radomes by the multi-nozzle extrusion process mentioned in this invention and the use of glass inter-layer elements to prevent cracks caused by CTE mismatch between layers can be considered and improved for different applications. Missile radomes operating at super and hypersonic speeds and in the wide/narrow frequency band, constructions required for high-speed aircraft or their components, electromagnetic windows and caps can be given as examples.

### REFERENCES

[1] M. T. Sebastian, H. Jantunen, Low Loss Dielectric Materials for LTCC Applications: A Review, International Materials Reviews, 2008, vol. 53 [2], 57-90.
[2] M. I. Ojovan, Viscosity and Glass Transition in Amorphous Oxides, Advances in Condensed Matter Physics, 2008, [817829], 1-24.

What is claimed is:

1. A method using 3D printing technology to produce multilayer ceramic/glass-ceramic radomes with CTE-compatible layers by the use of inter-layer transition materials providing an electromagnetic permeability in a wide frequency band, comprising the steps of:
(i) preparing a feed material to print by mixing predetermined compositions of at least a ceramic/glass-ceramic powder selected for each layer with organic binders enhancing a particle packing and by filling the each layer into single containers of a multi-nozzle 3D printing machine,
(ii) repeating step (i) for an inter-layer transition material, wherein the inter-layer transition material is a glass or other glassy materials.
(iii) preparing a computer-aided design file of a three-dimensional model of a desired radome and transferring the computer-aided design file to the multi-nozzle 3D printing machine,
(iv) initiating a multi-nozzle extrusion printing process in the multi-nozzle 3D printing machine in accordance with a printing order of ceramic and transition layers,
(v) debinding a green body printed in the ceramic and transition layers,
(vi) machining the green body to bring an object closer to a near-net shape after firing,
(vii) sintering the green body printed.

2. The method according to claim 1, further comprising the step of using glass transition elements to prevent cracks caused by Coefficient of Thermak Expansion (CTE) mismatch between printed ceramic/glass-ceramic layers.

3. The method according to claim 1, further comprising the step of machining the green body after step (v).

4. The method according to claim 1, wherein a debinding process is performed at temperatures below 500° C. and at heating rates of less than 1° C./min for removal of the organic binders.

5. The method according to claim 1, wherein the ceramic and transition layers are selected from ceramic/glass-ceramic materials to form a multilayered radome with a sandwich structure, wherein inner and outer layers of the multilayered radome are thin and have a high dielectric constant, and a middle layer of the multilayered radome is thick and has a relatively low dielectric constant.

6. The method according to claim 1, wherein the ceramic and transition layers are selected from ceramic/glass-ceramic materials to form a multilayered radome with a sandwich structure, wherein inner and outer layers of the multilayered radome are thick and have a low dielectric constant, and a middle layer of the multilayered radome is thin and has a relatively high dielectric constant.

7. The method according to claim 1, wherein the ceramic and transition layers are selected from ceramic/glass-ceramic materials to form a multilayered radome with a functionally-graded material structure, wherein a density/dielectric constant of each layer of the multilayered radome are vary.

8. The method according to claim 1, wherein the ceramic and transition layers are selected from ceramic/glass-ceramic materials to form a multilayered radome, wherein each layer of the multilayered radome is selected from different segments vertically according to a position of an RF seeker head.

9. The method according to claim 1, wherein ceramic/glass-ceramic materials are selected from the group consisting of SiO₂ (Silicon dioxide), Si₃N₄ (Silicon nitride), RBSN (Reaction Bonded Silicon Nitride), Al₂O₃ (Aluminum oxide), SiAlON (Silicon alumina nitride), LAS (Lithium Aluminum Silicate), and MAS (Magnesium Aluminum Silicate).

10. The method according to claim 9, wherein the LAS is a glass-ceramic material composed of Lithium-Aluminum-Silicate oxides in varying proportions around a principal composition 1Li₂O₃.1Al₂O₃.2SiO₂.

11. The method according to claim 9, wherein the MAS is a glass-ceramic material composed of Magnesium-Aluminum-Silicate oxides in varying proportions around a principal composition 2MgO.2Al₂O₃.5SiO₂.

12. The method according to claim 1, wherein glass inter-layer elements are selected from the group consisting of silicate glass oxides, borate glass oxides, compositions of the silicate glass oxides with modifying oxides from groups 1A and 2A of the periodic table, and intermediate oxides.

13. The method according to claim 12, wherein the silicate glass oxide is SiO₂ (Silicon dioxide).

14. The method according to claim 12, wherein the borate glass oxide is B₂O₃ (Boron trioxide).

15. The method according to claim 12, wherein the modifying oxides are Na₂O (Sodium oxide), K₂O (Potassium oxide), Li₂O (Lithium oxide), CaO (Calcium oxide), MgO (Magnesium oxide), BaO (Barium oxide) or PbO (Lead oxide).

16. The method according to claim 12, wherein the intermediate oxides are Al₂O₃ (Aluminium oxide), Bi₂O₃ (bismuth III oxide), or TeO₂ (Tellurium dioxide).

17. The method according to claim 12, wherein the glass inter-layer elements are PbO—B₂O₃—SiO₂ (PBS), ZnO—B₂O₃ (ZB), BaO—ZnO—B₂O₃ (BZB), La₂O₃—B₂O₃—ZnO (LBZ), BaO—Al₂O₃—SiO₂ (BAS), Li₂O—B₂O₃—SiO₂ (LBS), Li₂O—B₂O₃—SiO₂—CaO—Al₂O₃ (LBSCA), or BaO—B₂O₃—SiO₂ (BBS).

18. A multilayer ceramic and glass-ceramic radome produced by the method according to claim 1.

19. The multilayer ceramic and glass-ceramic radome according to claim 18, wherein the multilayer ceramic/glass-ceramic radome is used in missile radomes operating at super and hypersonic speeds and in a wide/narrow frequency band, or used for a high-speed aircraft and/or components of the high-speed aircraft, or in electromagnetic windows and caps.
